(19) United States
(12) Patent Application Publication
(10) Pub. No.: US 2005/0207568 A1
(43) Pub. Date: Sep. 22, 2005

(54) Low echo communicating apparatus and communicating method thereof

(76) Inventor: Te-Sun Wu, Hsinchu (TW)

Correspondence Address: J. C. PATENTS, INC., 4 VENTURE, SUITE 250, IRVINE, CA, 92618, US

(21) Appl. No.: 10/823,239

(22) Filed: Apr. 12, 2004

(30) Foreign Application Priority Data
Feb. 27, 2004 (TW) 93105041

(51) Int. Cl. H04R 25/00

(52) U.S. Cl. 379/430; 381/370

(57) ABSTRACT

A communicating apparatus generating low echo includes an output module, a receiving module and a control unit. The output module directs a remote voice signal outputted from the control unit, so that the remote signal is transmitted along a specific direction within a specific range. The receiving module receives a local signal, and transmits to the control unit thereby. Wherein the remote audio signal transmitted from the output module is excluded from the receiving module, thus echo is lowered significantly and communication quality is enhanced.

### CROSS-REFERENCE TO RELATED APPLICATION

This application claims the priority benefit of Taiwan application serial no. 93105041, filed on Feb. 27, 2004.

### BACKGROUND OF THE INVENTION

1. Field of Invention

The present invention relates to a communicating apparatus and method thereof, and more particularly, to a telephone system having an audio beam speaker and its communicating method thereof.

2. Description of the Related Art

It has always been an important issue to lower echo in a telephone system. One definition of echo in a telephone system is the audio signals propagated from a speaker feeding in a side tone format via an audio receiver back to the telephone system. This feedback loop induces oscillating and a consequent howl effect of the telephone system, thus communication quality thereof is downgraded.

Referring to FIG. 3, a conventional telephone system with echo is illustrated. In FIG. 3, the conventional telephone system is coupled to a speaker 31 and a receiver 33 via a control unit 35. When the control unit 35 commands the speaker 31 to generate an audio signal, since audio signals are transmitted based on traditional broadcast principles, part of the transmitted audio signals are fed back to the receiver 33 in a side tone format. Therefore an oscillating loop is formed, and a consequent howl effect adversely influences the telephone system.

In current telephone systems, a handsfree mode is generally available. When a telephone system is operated under handsfree mode, a user still opts to talk to the other party without holding up the handset. This design meets user's need, but since a receiver and a speaker of the telephone system are disposed considerably nearby, when the telephone system is switched to handsfree mode, audio signals are easily fed back through the receiver and thus a howl effect occurs.

Moreover, in the present cyber era, video communication is already being transformed into a new communication method, e.g. videoconference, which is especially beneficial to control internal affairs of international enterprises. In a communication system of a videoconference, echo is also one of the determinant configurations thereof. A conventional solution is to communicate with a simplex method, where either the speaker or the receiver of the system is working at a given time. Another conventional solution is to communicate with a duplex method, where both the speaker and the receiver work at the same time, yet echo signals are processed at backend to filter out the unexpected feedback noise. However this digital signal processing usually complicates the design of a communicating system.

### SUMMARY OF THE INVENTION

In light of the above, the present invention is directed to a communicating apparatus with low echo for minimizing echo and enhancing communication quality.

The present invention is also directed to a communicating apparatus with low echo, wherein echoic component of a signal is filtered out with a simple circuitry.

The present invention is also directed to a communicating method providing low echo with a duplex method, wherein echo is substantially lowered.

The communicating apparatus of a telephone system with low echo effect, according to an embodiment of the present invention, includes a directional speaker, a receiver and a control unit. The control unit is coupled to the directional speaker and the receiver, and is adapted for directing an electrical audio signal from a communicating network to audio signals to a directional signal for the directional speaker use. On the other hand, the directional audio-signal (e.g. user's voice) is transformed into an electrical audio signal by the control unit before transmitting to the communicating network. The receiver receives the audio signals excluding directional carrier wave signals that are transmitted from the directional speaker.

In an embodiment of the present invention, the directional carrier wave of the directional speaker is an ultrasonic wave. An ultrasonic wave has a characteristic of propagating along a specific direction in the air within a specific range. When the ultrasonic wave is being broadcast, it is self-demodulated back to the original audio signal after propagating for a certain distance through the air within the specific certain range. Moreover, the propagating direction of the foregoing ultrasonic carrier wave and the characteristic direction of the directional speaker form a solid angle being no larger than 30°, thus the receiver is spatially excluded from the specific range.

In an embodiment of the present invention, the communicating apparatus further includes a pre-compensating unit, an ultrasonic modulating unit, an amplitude modulation (AM) unit and a power amplifier. The pre-compensating unit is for compensating the audio signals transmitted from the control unit in a preceding stage before transmitting the compensated audio signals to the AM unit. The modulating unit is coupled to the pre-compensating unit and the ultrasonic modulating unit for respectively receiving compensated audio signals and ultrasonic carrier wave from the ultrasonic modulating unit so that the compensated audio signals are carried by the ultrasonic carrier wave. Moreover, the power amplifier is coupled to the acoustic generator of the AM unit and the directional speaker for amplifying the signals from the AM unit to transmit through a plurality of acoustic output components of the directional speaker.

According to another embodiment of the present invention, a low echo communicating apparatus is provided. The low echo communicating apparatus includes an output module, a receiving module and a control unit. The control unit is coupled to the output module and the receiving module, such that an electrical audio signal transmitted from one of the terminals of a communicating network is transformed to a remote audio signal with signal directing process. The directed audio signal is thus propagated in the air based on a specific direction. Moreover, a local audio signal (e.g. user's voice) from the receiving module transformed by the control unit is transmitted to the communicating network thereafter. The receiving module receives signals excluding remote audio signals transmitted from the output module.

To describe the aspect according to the present embodiment of the present invention more specifically, the output module directs the remote audio signals to a specific direction before transmitting, and the remote signal is propagated in the air along the specific direction within a specific range, which does not spatially cover the receiving module.

In yet another embodiment of the present invention, the receiving module comprises a receiver, and the output module comprises a pre-compensating unit, an ultrasonic modulating unit, an AM unit, a power amplifier and a directional ultrasonic transmitting device. The pre-compensating unit is adapted for compensating the remote audio signal from the control unit in a preceding stage whereto the AM unit. The modulating unit is coupled to the pre-compensating unit and the ultrasonic modulating unit is adapted for respectively receiving compensated remote audio signal and the ultrasonic carrier wave from the ultrasonic modulating unit, so that the ultrasonic carrier wave carries the remote audio signal. Moreover, the power amplifier is coupled to the AM unit and the directional ultrasonic beam transmitting device, for amplifying the signal from the AM unit and transmitting through a plurality of acoustic transmitting components of the directional ultrasonic beam transmitting device.

In an embodiment of the present invention, the communicating apparatus includes line telephone system, a cordless telephone system, a mobile phone system and an Internet telephone system, etc.

In yet another embodiment of the present invention, a communicating method with low echo effect is provided. The method includes the following steps. First, a remote audio signal is received by the transmitting end and is then transformed to a directional audio signal and outputted to the receiving end. Secondly, a receiving terminal of the receiving end receives local audio signal generated from the receiving end. And then the local audio signal of the receiving end is transmitted to the transmitting end.

In the foregoing method of transforming the remote audio signal to the directional audio signal, the remote audio signal is transformed to an ultrasonic carrier wave, and the ultrasonic carrier wave is self-demodulated through the air back to the original remote audio signal.

In light of the above description, a directional transmitting module is provided in which the audio signal is highly directional and is propagated in a specific range. Therefore, communication is done with a multiplex method according to the present invention, and echo effect thereof is substantially lowered.

Moreover, the method of filtering feedback echo is to direct an output audio signal to a specific direction. Thus quality telephony is achieved without complicated circuitry.

### BRIEF DESCRIPTION OF THE DRAWINGS

FIG. 1 is a schematic block diagram illustrating a communicating apparatus with low echo according to one embodiment of the present invention.

FIG. 2 is a flowchart diagram illustrating a communicating method with low echo according to one embodiment of the present invention.

FIG. 3 is a diagram illustrating a conventional telephone system and echo voice.

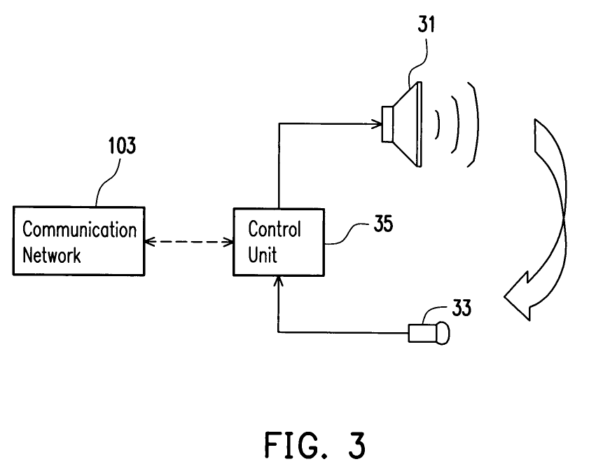

### DESCRIPTION OF THE EMBODIMENTS

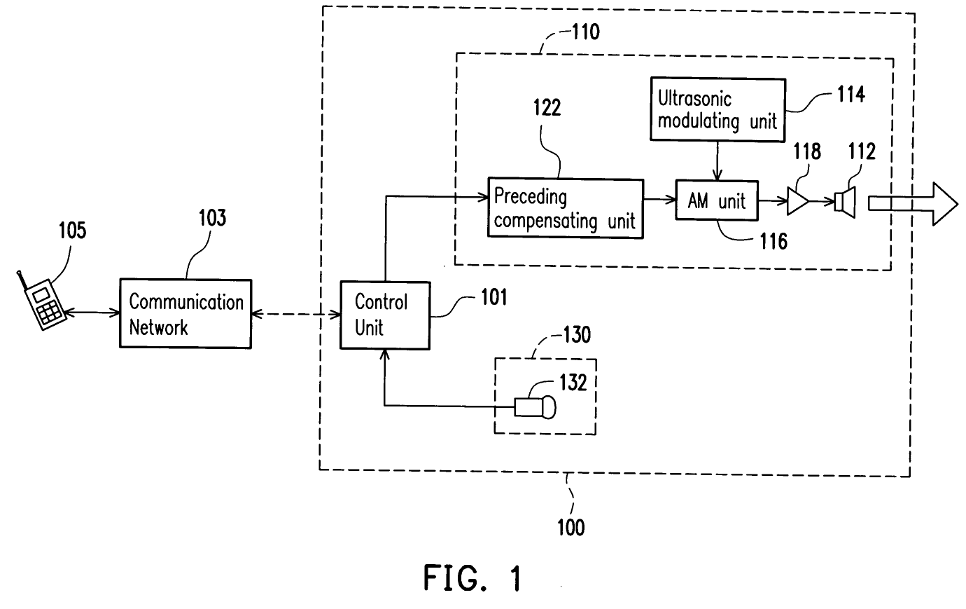

Referring to FIG. 1, a schematic block diagram of a communicating apparatus with low echo according to one embodiment of the present invention is illustrated. As shown in FIG. 1, a communicating apparatus 100 includes a control unit 101 coupling to an output module 110 and a receiving module 130, for transforming a digital electrical audio signal transmitted from the communicating network 105 into a signal, e.g. analog remote audio signal, to the output module 110; or for transforming a local analog audio signal, e.g. user's voice, into a digital electrical audio signal from the receiving module 130 to transmit to the communicating network 105.

Referring to FIG. 1, when the control unit 101 transmits the remote audio signal to the output module 110, the output module 110 directs the audio signal according to a specific direction before transmitting thereby, such that the outputted remote signal is highly directional. In other words, the remote audio signal transmitted from the output module 110 is transmitted within a specific range along a specific direction.

Referring to FIG. 1, the output module 110 transforms the remote audio signal into a directional carrier wave, e.g. an ultrasonic carrier wave, according to the embodiment of the present invention. Since an ultrasonic wave is transmitted with high directionality, the ultrasonic carrier wave from the output module 110 propagates through the air within a specific range along a specific direction, and the ultrasonic wave is self-demodulated via air media. Therefore, the ultrasonic carrier wave is demodulated back to original remote audio signal from the control unit 101. Moreover, the specific propagation direction of the foregoing ultrasonic carrier wave and a characteristic direction of the output module 110 form a solid angle engineered to be no larger than 30°, therefore the specific range does not spatially cover the receiving module 105. Consequently, the remote audio signal is not fed back to the communicating apparatus 100 via the receiving module 130. In other words, the receiving module 130 receives audio signals (e.g. local user's voice) excluding the remote audio signal from the output module 110. Therefore, echo phenomenon is substantially lowered.

In the embodiment of the present invention, an ultrasonic carrier wave generating circuit is provided. Referring to FIG. 1, a pre-compensating unit 122 is coupled to the control unit 101 in the output module 110, for compensating the remote audio signal propagated by the control unit 101 in a preceding stage. The purpose of the pre-compensating operation is for demodulating the ultrasonic carrier wave from the output module 110 rapidly within a short range in the air. An output terminal of the pre-compensating unit 122 is coupled to an amplitude modulating (AM) unit 116, and the AM unit 116 is coupled to the ultrasonic modulating unit 114. The ultrasonic modulating unit 114 provides an ultrasonic carrier wave, so that the remote audio signal compensated by the pre-compensating unit 122 is carried by the ultrasonic carrier wave via the AM unit 116.

The AM unit 116 is coupled to the power amplifier 118 coupled to the directional ultrasonic beam transmitting device, e.g. a directional speaker 112. An ultrasonic carrier wave generated by the AM unit 116 is amplified by the power amplifier 118 and output via a plurality of acoustic transmitting components (not shown in the figure) of the directional speaker 112.

Referring to FIG. 1, the receiving module 130 includes a receiver 132. The receiver 132 (e.g. a microphone) is adapted for receiving external audio signal out of the communicating apparatus 100, e.g. a local user's voice, whereas the audio signal demodulated from the ultrasonic carrier wave from the output module is excluded. The reason is described above and same description is not repeated herein.

Although the invention has been described with reference to an ultrasonic carrier wave transformed from the audio signal for propagation purpose according to an embodiment thereof, it will be apparent to those skilled in the art that any output module that direct an audio signal based on a specific direction for propagation is within the scope of the present invention.

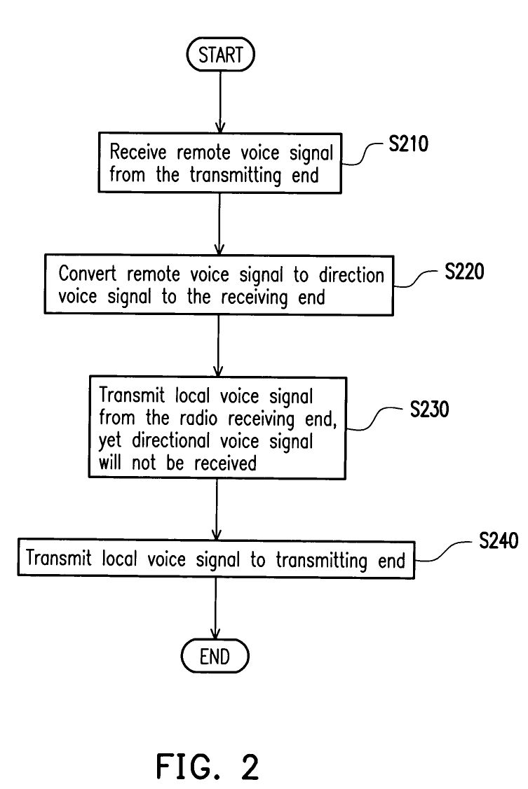

Referring to FIG. 2, a flowchart diagram of a communicating method with low echo according to one embodiment of the present invention is illustrated herein. In light of the method in above description, a communicating method is provided in the present invention. Referring to FIG. 1 as well as FIG. 2, a remote audio signal from the transmitting end 105 is transmitted via the communicating network 105 as shown in step S210. The remote audio signal is then transformed into a directional audio signal (e.g. ultrasonic carrier wave) to the receiving end as shown in step S220 according to the communicating apparatus 100 of the present invention.

On the other hand, the communicating apparatus 100 according to an embodiment of the present invention also receives local audio signal (e.g. user's voice) from the receiving end (e.g. the receiving module 130) as shown in step S230. However, the receiving end does not receive directional audio signal (e.g. audio signal from the output module 110). The communicating apparatus 100 then transmits the local audio signal to the transmitting end 105 via the communicating network 105 as shown in step S240.

In light of the above, the communicating system in the present invention has at least the following advantages.

1. The directional transmitting device, according to an embodiment of the present invention, is suitable for communicating apparatuses such as a line/cordless telephone system, a mobile telephone system, an Internet telephone system or a walkie-talkie system. The directional transmitting device is used lower the occurrence of echo in the communicating system.

2. The directional transmitting device is adapted for transmitting audio signal along a specific direction, therefore conversation between receiving/transmitting parties is more secured from being intercepted.

3. Since a user receives audio signal from the other party as well to transmit audio signal at the same time, switching operation between speaker and receiver can be skipped.

4. Since the receiving module of the present invention is not disposed within digital signal processing circuit for filtering echo, circuitry thereof is substantially simplified.

Although the invention has been described with reference to a particular embodiment thereof, it will be apparent to those skilled in the art that modifications to the described embodiment may be made without departing from the spirit of the invention. Accordingly, the scope of the invention will be defined by the attached claims and not by the above detailed description.

1. A communicating apparatus, suitable for a telephone system, comprising:
a directional speaker, for transmitting a directional carrier wave to a user;
a receiver, for receiving at least an audio signal produced by a user such that the directional carrier wave is not received by the receiver; and
a control unit, coupled to the directional speaker and the receiver, for transmitting an electrical audio signal received from the directional speaker, and for transforming the audio signal received from the receiver into an electrical audio signal and transmitting to the communicating network.

2. The communicating apparatus as recited in claim 1, wherein the directional carrier wave includes an ultrasonic carrier wave, and wherein the ultrasonic carrier wave propagates along a predetermined direction within a predetermined range in the air.

3. The communicating apparatus as recited in claim 2, wherein the ultrasonic carrier wave is self-demodulated back to the audio signal through the air within the predetermined range.

4. The communicating apparatus as recited in claim 3, wherein the receiver is spatially excluded from the predetermined range.

5. The communicating apparatus as recited in claim 3, wherein the predetermined direction and a characteristic direction of the directional speaker form a solid angle smaller than about 30°.

6. The communicating apparatus as recited in claim 1, wherein the directional speaker comprises a plurality of acoustic transmitting units.

7. The communicating apparatus as recited in claim 6 further comprising:
a pre-compensating unit, for receiving the audio signal and compensating the audio signal in a preceding stage and outputting a compensated audio signal;
an ultrasonic wave modulating unit, for providing an ultrasonic carrier wave;
an amplitude modulating unit, for receiving the compensated audio signal and receiving the ultrasonic carrier wave, such that the compensated audio signal is carried by the ultrasonic carrier wave; and
a power amplifier, for receiving an output from the amplitude modulating unit.

8. A communicating apparatus, comprising:
an output module, for polarizing a remote audio signal so as to propagate the remote audio signal directionally in the air;
a receiving module, for receiving at least a local audio signal generated by a user, wherein the remote audio signal is not received by the receiving module; and
a control unit, coupled to the output module and the receiving module, for transforming an electrical audio signal transmitted from a communicating network into the remote audio signal, transmitting the transformed local audio signal from the electrical signal to the communicating network, allowing the user to communicate with a communicating terminal via the communicating apparatus through the communicating network.

9. The communicating apparatus as recited in claim 8, wherein the remote audio signal propagates within a predetermined range along a predetermined direction, and the receiving module is spatially excluded from the predetermined range.

10. The communicating apparatus as recited in claim 8, wherein the output module comprises:
a pre-compensating unit, for compensating the remote audio signal in a preceding stage;
an ultrasonic modulating unit, for providing an ultrasonic carrier wave;
an amplitude modulating unit, coupled to the pre-compensating unit and the ultrasonic modulating unit, for receiving the compensated remote audio signal and the ultrasonic carrier wave, so as to carry the remote audio signal with the ultrasonic carrier wave;
a power amplifier, for receiving an output of the amplitude modulating unit; and
a directional ultrasonic beam transmitting device, for transmitting the ultrasonic carrier wave to the user, wherein the ultrasonic carrier wave is self-demodulated back to the remote audio signal through air.

11. The apparatus as recited in claim 10, wherein the directional ultrasonic beam transmitting device comprises a plurality of acoustic transmitting units.

12. The apparatus as recited in claim 8, wherein the communicating apparatus comprises at least one selected from a group consisting of a line telephone system, a cordless telephone system, a mobile phone system and an Internet telephone system.

13. The apparatus as recited in claim 8, wherein the receiving module comprises a receiver.

14. A communicating method for a communicating system generating low echo, comprising:
receiving a remote audio signal from a transmitting end;
transforming the remote audio signal into a directional audio signal for a receiving end;
receiving a local audio signal received by a receiving terminal of the receiving end, wherein the directional audio signal does not propagate through the receiving terminal; and
transmitting the local audio signal to the transmitting end.

15. The communicating method as recited in claim 14, wherein the directional audio signal propagates along a predetermined direction within a predetermined range.

16. The communicating method as recited in claim 14, wherein the step of transforming the remote audio signal into the directional audio signal comprises transforming the remote audio signal to an ultrasonic carrier wave.

17. The communicating method as recited in claim 16, wherein the ultrasonic carrier wave is self-demodulated back to the remote audio signal through air.
